(19) United States
(12) Patent Application Publication
(10) Pub. No.: US 2020/0279711 A1
(43) Pub. Date: Sep. 3, 2020

(54) PYROTECHNIC SWITCHING DEVICE

(71) Applicants: ARIANEGROUP SAS, Paris (FR); MERSEN FRANCE SB SAS, Saint-Bonnet-de-Mure (FR)

(72) Inventors: Alexandre MATHIEU, Pibrac (FR); Romain LORENZON, Eysines (FR); Jean-François DE PALMA, Saint Barthelemy d'Anjou (FR)

(73) Assignees: ARIANEGROUP SAS, Paris (FR); MERSEN FRANCE SB SAS, Saint-Bonnet-de-Mure (FR)

(21) Appl. No.: 16/763,631

(22) PCT Filed: Nov. 13, 2018
(86) PCT No.: PCT/FR2018/052819

§ 371 Date: May 13, 2020

(30) Foreign Application Priority Data
Nov. 14, 2017 (FR) 1760702

(51) Int. Cl. H01H 85/165; H02H 1/00

(52) U.S. Cl. CPC H01H 85/165; H02H 1/0007

(57) ABSTRACT

A pyrotechnic switching device comprising a first and a second pyrotechnic initiators, and a body in which are present: an electrically conductive portion, and a mobile switching element having an insulating relief facing the conductive portion. The device also comprises a fuse element connected in series with the conductive portion, the first initiator being connected to the terminals of the fuse element so that tripping the fuse element actuates the first initiator, each initiator being configured to cause the device to switch from a current conducting configuration to a current interrupting configuration, the mobile switching element being set in motion toward the conductive portion in order to break it by the impact of the relief during switching from the first to the second configuration.

### BACKGROUND OF THE INVENTION

The present invention relates to the general field of electrical switching devices, and more particularly to those of the type using pyrotechnic actuation. The invention also relates to an electrical power supply system secured by a device of this type.

Pyrotechnic switching devices are known comprising a body in which is present a pyrotechnic initiator configured, when it is triggered, to set in motion a piston provided with a relief in the direction of a conductive bar, to cut through it. Documents WO 2016/038043 and WO 2016/038050 show examples of devices of this type which allow accomplishing switching in the event of excess current in a circuit.

It would be desirable to switch the current, not only in the event of excess current, but also when a non-electrical anomaly occurs (a shock for example). There exists therefore a need to dispose of a reliable, compact and low-cost switching solution to accomplish this.

### Object and Summary of the Invention

The present invention therefore has the purpose of mitigating disadvantages of this type by proposing a pyrotechnic switching device comprising a first and a second pyrotechnic initiators, and a body in which are present:
an electrically conductive portion of which at least a part is present in a chamber present in the body, and
a mobile switching element delimiting the chamber and having an electrically insulating relief which faces the conductive portion.

The device also comprises a fuse element connected in series with the conductive portion and configured to trip when the intensity of the current passing through it exceeds a predetermined value, the first initiator being connected to the terminals of the fuse element so that tripping the fuse element actuates the first initiator, each initiator being configured to cause the switching device to switch from a first current conducting configuration to a second current interrupting configuration, the mobile switching element being set in motion toward the conducting portion in order to break it by the impact of the relief during switching from the first to the second configuration. When the current passing through the conducting portion reaches the tripping threshold of the fuse (predetermined current value), all the current then passes through the first initiator, which also causes its tripping and the interruption of the current due to breakage of the conductive portion. When the second initiator is tripped, for example by means of a control element outside the device, the conductive portion is also broken and the current is interrupted.

The switching device according to the invention thus allows disposing of the advantages of a switching device tripped automatically by overrunning the current threshold (first initiator), and another switching device tripped by another anomaly (second initiator), without the bulk that mounting two devices of this type in series would produce. The use of two distinct initiators which are then tripped by separate connectors allows avoiding coupling between the fuse element and the control element which would result from the use of a single initiator which would be connected both to a fuse element and to a control element. Coupling of this type could then impair the control element in the event of overrunning the threshold value of the current at which the fuse element is tripped. The device according to the invention is thus reliable, simple and compact in design, and preserves the integrity of the control element which can be connected to the second initiator in the event of tripping in response to overrunning the current threshold.

Each initiator can have an output, each output being in communication with a pressurization chamber delimited by the mobile switching element. The mobile switching element can thus separate the pressurization chamber from the chamber in which the conductive portion is present. The mobile switching element can thus be a piston having a cross section of oblong shape in a plane perpendicular to an axis along which it moves in the switching device.

In one exemplary embodiment, the mobile switching element can be configured to break the conductive portion by the impact of the relief at a zone distinct from that where the fuse element is present during switching from the first to the second configuration.

In one exemplary embodiment, the fuse element can be present inside the body. In particular, the fuse element can be present in the chamber in which the conductive portion is present.

In one exemplary embodiment, the fuse element can be present in a second chamber present in the body and distinct from the chamber in which the conductive portion is present. This second chamber can be a cavity present inside the body, for example positioned under the conductive portion.

In one exemplary embodiment, the fuse element can be present in an insulating shell containing a powder of an electrically insulating material.

In one exemplary embodiment, the fuse element can be applied to the conductive portion.

In one exemplary embodiment, the fuse element can consist of a thinned zone of the conducting portion.

In one exemplary embodiment, the mobile switching element can comprise at least one second relief facing the conductive portion, and the conductive portion can have at least one guide slot intended to cooperate with the second relief during switching from the first to the second configuration, the second relief being closer to the conductive portion, in the first configuration, than the insulating relief. This type of positioning improves the reliability of switching. In fact, during switching from the first to the second configuration, and before the impact of the insulating relief on the conductive portion, the second relief will engage in the corresponding slot of the conductive portion and will allow the piston to be guided which still holding in position the conductive portion at the time of impact with the piston. In one exemplary embodiment, the second relief can extend transversely relative to the relief which is intended to impact on the conductive portion. In one exemplary embodiment, the second relief can extend from a lower face of the mobile switching element over a greater distance than the distance over which the relief extends which is intended to impact on the conductive portion of said face.

In one exemplary embodiment, the device can also comprise an additional fuse element connected in parallel to the conductive portion, said additional fuse element being configured to trip when the intensity of the current passing through it exceeds a predetermined value, said additional fuse element having a pre-arc time greater than the time taken by the switching device to switch from the first configuration to the second configuration.

During a normal operation of the system (i.e. when the switching device is in the first configuration), the additional fuse element is conducting, current passes through the conductive portion and the additional fuse element. On the other hand, when the intensity of the current passing through the electrical circuit exceeds the predetermined value for the fuse element connected in series with the conductive portion or when an initiator is tripped by the control element, the switching device switches into the second configuration. The additional fuse element being selected to have a pre-arc time greater than the time taken for disconnecting the conductive portion, the additional fuse element is always conducting at the time when the switching device arrives in the second configuration. In this manner, the additional fuse element short-circuits the switching device, avoiding the appearance of an electric arc within the latter. Secondly, the current circulating in the additional fuse element will melt the latter, which will cause the complete interruption of the electrical current circulating in the circuit. What is meant by “pre-arc time” is, in a manner known per se, the time that the additional fuse element takes to melt and volatilize when a current with an intensity greater than or equal to a predetermined value passes through it.

One advantage of the second fuse element is that the formation of an electric arc at the broken conductive portion is avoided, because the current can still circulate in the additional fuse element during a short period before the latter is tripped and interrupts the circuit. In addition, as the additional fuse element is subjected during this instant to the entire intensity circulating in the electrical circuit, its operation is reliable. This advantageously allows improving the reliability of the electrical switching performed.

In one embodiment, the switching current of the additional fuse element (predetermined current value) can be equal to a nominal electrical current value defined as being less than or equal to four times the maximum value of current intended to circulate in the device in normal operation. In one embodiment, the switching voltage (or breakdown voltage) of the additional fuse element can be greater than or equal to a nominal voltage value defined as being the maximum voltage value intended to be applied to the terminals of the device in normal operation.

The invention also has as its object a secured power supply system comprising at least:
a switching device like that presented above,
a power supply circuit connected to the switching device, the conductive portion being connected to the power supply circuit, and
a control element configured to actuate the second initiator when an anomaly is detected.

In one exemplary embodiment, the anomaly can be a non-electrical anomaly. What is meant by “non-electrical anomaly” is for example a shock, i.e. a sudden movement of the control element to which the switching device can be connected, or overrunning the temperature or pressure threshold in the environment of the control element.

The invention also applies to a secured electrical system comprising a secured power supply system as defined above, and a device supplied by said secured power supply system. An electrical installation can comprise a secured electrical system of this type.

A secured electrical system of this type can be located, for example, in a motor vehicle, an airplane, a train, a photovoltaic installation, an autonomous domestic installation.

### BRIEF DESCRIPTION OF THE DRAWINGS

Other features and advantages of the present invention will be revealed by the description given below, with reference to the appended drawings which illustrate an embodiment of it free of any limiting character. In the figures:

FIG. 1 is an exploded view in perspective of a switching device according to a first embodiment of the invention,

FIGS. 2A and 2B show a switching device according to one embodiment of the invention, respectively in the first and in the second configuration in transverse section along planes IIA and IIB of FIGS. 3A and 3B,
FIGS. 3A and 3B show longitudinal section views of the switching device respectively in the configurations of FIGS. 2A and 2B along longitudinal planes IIIA and IIIB separating the two initiators,

FIG. 4 shows a secured electrical system comprising a secured power supply system according to one embodiment of the invention,

FIGS. 5 and 6 show respectively a switching device according to a second embodiment of the invention in longitudinal section and the conductive portion used in this embodiment,

FIG. 7 shows a switching device according to a third embodiment of the invention in longitudinal section, and

FIG. 8 shows a switching device according to a fourth embodiment of the invention within a secured electrical system like that of FIG. 4.

### DETAILED DESCRIPTION OF THE INVENTION

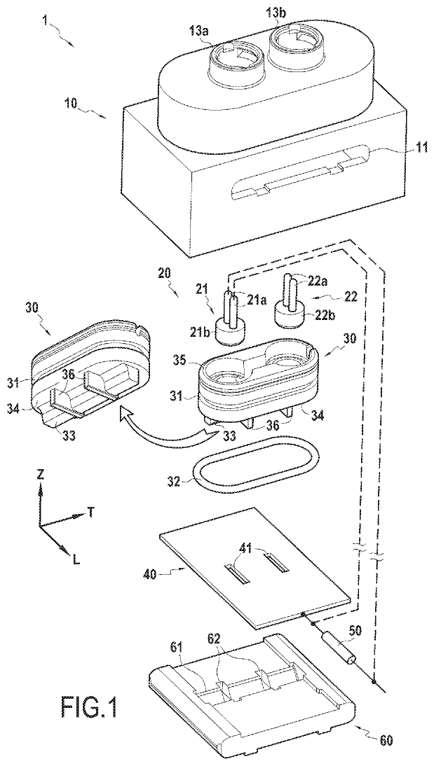

FIG. 1 shows an exploded view of a switching device 1 according to a first embodiment of the invention. The illustrated switching device 1 comprises: a body 10, a pyrotechnic initiation system 20, a piston 30, a conductive portion 40, a fuse element 50, and a support 60. The fuse element 50 is, according to the invention, connected in series with the conductive portion 40. In the example illustrated, the longitudinal direction L corresponds to the direction in which the conductive portion 40 extends in the device 1. The transverse direction T is perpendicular to the direction L in the plane of the conductive portion 40.

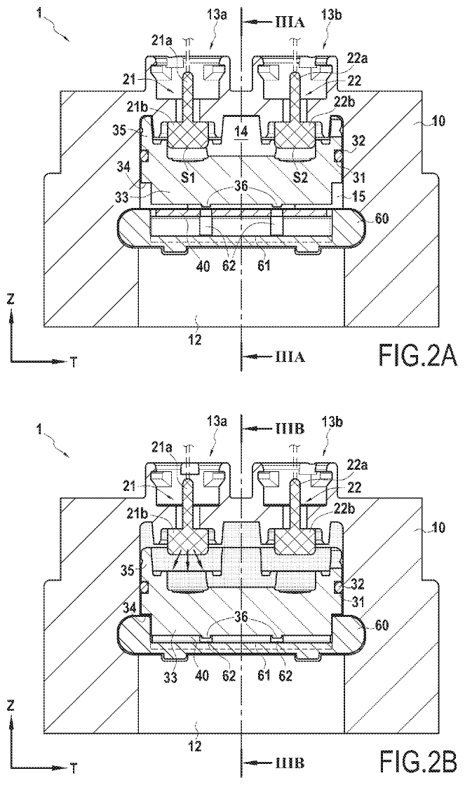

The body 10 comprises two lateral openings 11 on two opposite faces of the body 10 (only one lateral opening 11 is visible in FIG. 1) by which the support 60 can be inserted into the interior of the body 10, a lower opening 12 (FIGS. 2A-3B) by which the piston 30 can be inserted into the interior of the body 10, and two upper openings 13a and 13b protruding on an upper face of the body 10. The pyrotechnic initiation system 20 comprises a first pyrotechnic initiator 21 and a second pyrotechnic initiator 22, respectively equipped with electrical connectors 21a and 22a which pass through the openings 13a and 13b. The lateral openings 11 continue in the longitudinal direction L and join one another inside the body 10 to form a housing in which the support 60 is retained in the body 10.

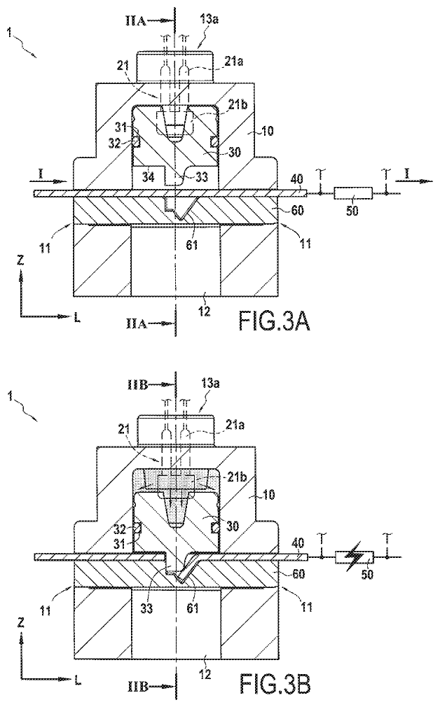

Each of the electrical connectors 21a and 22a of the pyrotechnic initiators 21 and 22 is configured to initiate a pyrotechnic charge 21b and 22b to which they are connected. Each pyrotechnic charge 21b and 22b is, when it is initiated (they can be initiated separately), for example by means of a current passing through the electrical connectors 21a or 22a, capable of generating a pressurization gas by its combustion. According to the invention, the first pyrotechnic initiator 21 is connected, here by means of its connectors 21a, in parallel with the fuse element 50 (i.e. connected to the terminals of the fuse element 50).The second pyrotechnic initiator 22 can be connected by means of its connectors 22a to a control element C (FIG. 4) configured to actuate the second pyrotechnic initiator 22 when an anomaly is detected.

The piston 30, constituting a mobile switching element within the meaning of the invention, has a cross section of oblong shape in a plane perpendicular to a vertical direction Z of the switching device 1. The direction Z corresponds to the direction in which the piston 30 moves in the switching device 1, and here is perpendicular to the directions L and T. Here the switching device 1 comprises a single piston 30. The piston 30 comprises a circumferential recess 31 in which a seal 32, for example an O ring seal, is intended to be housed. When the piston 30 is in the switching device 1, the O ring seal 32 ensures sealing between the body 10 and the piston 30. The piston 30 can move in the direction Z inside the body 10 between a high position (first position, device in the first configuration), as in FIGS. 2A and 3A, and a low position (second position, device in the second configuration), as in FIGS. 2B and 3B.As long as a pyrotechnic initiator 21 or 22 has not been tripped, the piston 30 is held in the high position. Of course, the piston 30 can have a different shape from that illustrated, suited to the shape of the cavity inside the body in which it moves.

As illustrated in FIGS. 2A-2B and 3A-3B, the body 10 comprises a pressurization chamber 14 in communication with the outputs S1 and S2 of the pyrotechnic initiators 21 and 22, and a chamber 15 in which is present the conductive portion 40. The piston 30 thus hermetically separates the pressurization chamber 14 from the chamber 15 by means of the seal 32.

In conformity with the invention, the piston 30 has an electrically insulating relief. More precisely, the piston 30 comprises here a lower face 34 from which protrudes the relief 33. The relief 33 is positioned facing the conductive portion 40. The relief 33 generally extends here in the transverse direction T. The relief 33 has here a dimension in the transverse direction T which is equal to or slightly greater than the dimension, in this same direction T, of the conductive portion 40. The relief 33 also extends in the direction L and has a nonzero thickness in this direction L. The piston 30 comprises here, on the initiators 21 and 22 side, a skirt 35 delimiting the pressurization chamber 14 and allowing guiding the piston 30 in the body 10.

The conductive portion 40 takes, in the example illustrated, the shape of a plate having a dimension in the longitudinal direction L which is greater than the dimension in this same direction of the body 10 so as to protrude on either side of the switching device 1, through the lateral openings 11. In the example illustrated, the conductive portion 40 comprises two guide slots 41 extending here in the longitudinal direction L, which are intended to cooperate with longitudinal reliefs 36 (second reliefs) protruding on the lower face 34 of the piston 30 after the tripping of an initiator 21 or 22. The longitudinal reliefs 36, in the first configuration, are closer to the conductive portion 40 than the relief 33. The cooperation of the reliefs 36 and the slots 41 allows guiding the piston 30 at the moment of breakage of the conductive portion 40 while still holding it in position, which improves the reliability of switching.

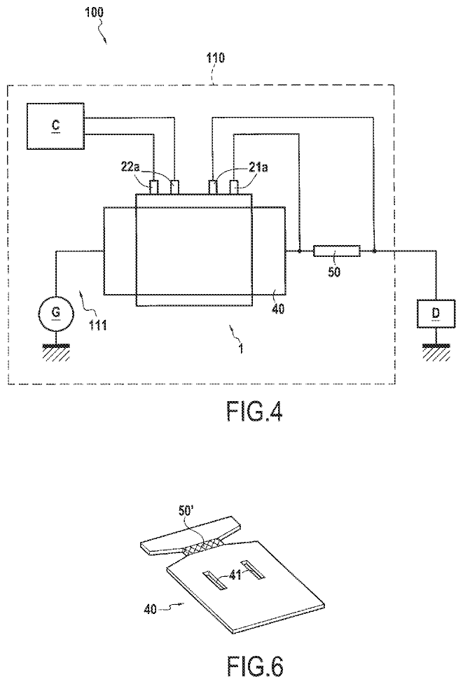

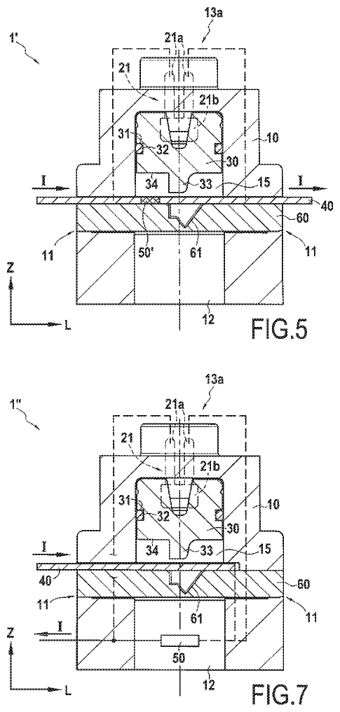

The fuse element 50 takes, in the example illustrated, the shape of a commercial fuse, i.e. it is present in an insulating shell containing a powder of an electrically insulating material. For example, the fuse element 50 can comprise a fusible wire present in silica powder. The fuse element 50 can, as in the example illustrated, be present outside the body or, as a variant, inside the body, as in the examples of FIGS. 5 to 7 which will be subsequently described. When it is inside the body, the fuse element 50 can be present in the chamber 15 or in a second chamber distinct from it, as in the example of FIG. 7 which will be subsequently described. The fuse element 50 can, as in the example illustrated here, be applied to the conductive portion 40 or, as a variant, consist of a thinned zone of the conductive portion, as in the example of FIGS. 5 and 6 which will be subsequently described.

The support 60 takes, in the example illustrated, the shape of a drawer in which the conductive portion 40 is present. In the example illustrated, the support 60 is configured to retain the conductive portion in position in the switching device 1, for example by providing a corresponding housing there. Here the support 60 is equipped with a recess 61 which extends in the transverse direction T and in which the relief 33 is intended to be received after the tripping of one of the pyrotechnic initiators 21 and 22, once the conductive portion 40 has been cut. The recess 61 in the support thus allows locking the piston 30 in the second position and ensuring definitive cutting of the conductive portion 40. Notches 62 corresponding to the longitudinal reliefs 36 can be present in the support 60 to house said reliefs 36 when the device 1 reaches the second configuration.

The operation of the device 1 will now be briefly described in connection with FIGS. 2A-2B and 3A-3B. In FIGS. 2A and 3A, the switching device 1 is not yet tripped and is in the first configuration, corresponding for example to a storage or transport configuration. In this configuration, the piston 30 is in a first position, or high position. The conductive portion 40 is intact and a current I (FIG. 3A) can pass through it. Then, two situations can occur. In a first situation, which is illustrated in FIGS. 2A-2B and 3A-3B, the current I exceeds the predetermined value or tripping threshold of the fuse element 50 and trips it (FIG. 3B), generally by melting it, which has the effect of diverting the entire current to the first pyrotechnic initiator 21, which then also trips. In a second situation which is not illustrated in the figure, it is the second pyrotechnic initiator 22 which is tripped in response to an outside signal originating for example from a control element C (FIG. 4) in response to an anomaly. The tripping of one or the other pyrotechnic initiators 21 or 22 then generates a combustion gas which pressurizes the pressurization chamber 14 and sets the piston 30 in motion in the direction Z toward the conductive portion 40. The piston 30 then cuts by impact the conductive portion 40 (FIGS. 2B and 3B) and interrupts the current in the switching device 1. The switching device 1 then finds itself in the second configuration, the relief 33 of the piston being received in the recess 61 of the support 60. In all the examples illustrated, the piston 30 breaks the conductive portion by the impact of the relief at a zone distinct from that where the fuse element 50 is present. In a non-illustrated variant, the piston 30 can cut the conductive portion by the impact of the relief at the zone where the fuse element is present, for example when the fuse element constitutes a thinned zone of the conductive portion.

FIG. 4 shows an example of a secured electrical system 100 implementing a switching device 1 according to one embodiment of the invention. The secured electrical system 100 comprises a secured power supply system 110 comprising a switching device 1 (shown very schematically) and a power supply circuit 111. The power supply circuit 111 comprises here an electrical generator G connected to one end of the conductive portion of the switching device 1. The electrical generator G can for example be a battery or an alternator. In the switching device 1, the fuse element 50 is connected in series with the conductive portion 40, and the first pyrotechnic initiator 21 is connected in parallel, by means of its connectors 21a, to the fuse element 50. The secured power supply system 110 also comprises a control element C configured to actuate the second pyrotechnic initiator 22 when an anomaly is detected. The control element C is connected to the second pyrotechnic initiator 22 by means of the connectors 22a. The anomaly in response to which the control element C can trip the second initiator 22 can be a non-electrical anomaly such as the detection of a shock, for example a sudden deceleration of the control element, a change of temperature, of pressure, etc. In the event of the detection of an anomaly, the control element C is able to send an electrical current to the second pyrotechnic initiator 22 for tripping it in order to interrupt the current, as previously described. Finally, the secured electrical system 100 comprises an electrical device D connected to the fuse element 50 of the switching device 1 to be supplied by the secured power supply system 110. By way of an example, a motor vehicle can comprise a secured electrical system 100.

The switching device 1 described previously has a single conductive portion 40. However, it does not depart from the scope of the present invention if the device has several conductive portions, for example two or three conductive portions, which can be broken simultaneously by the relief of the mobile switching element.

FIGS. 5 and 6 show respectively a switching device 1′ according to a second embodiment of the invention in longitudinal section, and the conductive portion 40 that it comprises. The device 1′ differs from the device 1 described previously by the fact that the fuse element 50′ constitutes a thinned zone of the conductive portion 40, as can be seen better in FIG. 6. Electrical wires (shown by dotted lines) can thus be provided in the device 1′ to connect the connectors 21a of the first initiator 21 in parallel with the fuse element 50′, as illustrated in FIG. 5. The switching device 1′ operates in the same manner as the device 1 described previously.

Finally, FIG. 7 shows a switching device 1″ according to a third embodiment of the invention, in longitudinal section. The device 1″ differs from the device 1 described previously by the fact that the fuse element 50 is present inside the body 10 and in a second chamber, consisting here of a cavity formed by the opening 12 and delimited by the support 60, distinct from the chamber 15. As before, electrical wires (shown by dotted lines) can be provided in the device 1″ to connect the connectors 21a of the first initiator 21 in parallel with the fuse element 50, as shown in FIG. 7. The switching device 1″ operates in the same manner as the devices 1 and 1′ described previously.

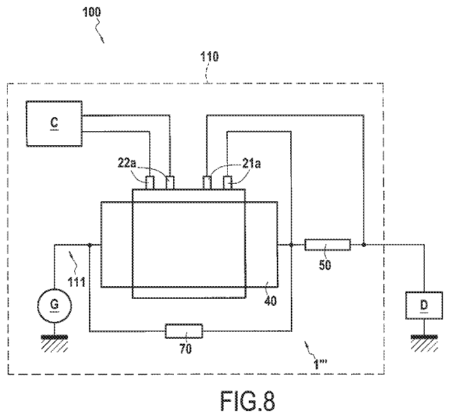

FIG. 8 shows a secured electrical system 100 similar to that illustrated in FIG. 4. Thus identical reference symbols between FIGS. 4 and 8 designate identical features. The switching device 1′″ according to a fourth embodiment of the invention, present in the system 100 of FIG. 8, also comprises a fuse element 70 (additional fuse element) connected in parallel to the conductive portion 40 in order to prevent the formation of an electrical arc at the conductive portion 40 when this breaks. The fuse element 70 is connected directly to the two ends of the conductive portion 40. The fuse element 70 can have a cut-off current, i.e. a predetermined current value beginning at which it trips, less than or equal to four times the maximum value of current intended to circulate in the electrical circuit during normal operation; and a cut-off voltage or breakdown voltage greater than or equal to the maximum voltage value intended to be applied to the terminals of the conductive portion 40 in normal operation.

1. A pyrotechnic switching device comprising a first and a second pyrotechnic initiators, and a body in which are present:
an electrically conductive portion of which at least a part is present in a chamber present in the body, and
a mobile switching element delimiting the chamber and having an electrically insulating relief which faces the conductive portion,
the device also comprising a fuse element connected in series with the conductive portion and configured to trip when the intensity of the current passing through it exceeds a predetermined value, the first initiator being connected to the terminals of the fuse element so that tripping the fuse element actuates the first initiator, each initiator being configured to cause the switching device to switch from a first current conducting configuration to a second current interrupting configuration, the mobile switching element being set in motion toward the conductive portion in order to break it by the impact of the relief during switching from the first to the second configuration.

2. The device according to claim 1, wherein the mobile switching element is configured to break the conductive portion by the impact of the relief at a zone distinct from that where the fuse element is present during switching from the first to the second configuration.

3. The device according to claim 1, wherein the fuse element is present inside the body.

4. The device according to claim 3, wherein the fuse element is present in the chamber in which the conductive portion is present.

5. The device according to claim 1, wherein the fuse element is present in a second chamber present in the body and distinct from the chamber in which the conductive portion is present.

6. The device according to claim 1, wherein the fuse element is present in an insulating shell containing a powder of an electrically insulating material.

7. The device according to claim 1, wherein the fuse element is applied to the conductive portion.

8. The device according to claim 1, wherein the fuse element consists of a thinned zone of the conductive portion,

9. The device according to claim 1, wherein the mobile switching element comprises at least one second relief facing the conductive portion, and the conductive portion has at least one guide slot intended to cooperate with the second relief during switching from the first to the second configuration, the second relief being closer to the conductive portion, in the first configuration, than the insulating relief.

10. The device according claim 1, also comprising an additional fuse element connected in parallel to the conductive portion, said second fuse element being configured to trip when the intensity of the current passing through it exceeds a predetermined value, said second fuse element having a pre-arc time greater than the time taken by the switching device to switch from the first configuration to the second configuration.

11. A secured power supply system comprising at least:
a switching device according to claim 1,
a power supply circuit connected to the switching device, the conductive portion being connected to the power supply circuit, and
a control element configured to actuate the second initiator when an anomaly is detected.

12. The system according to claim 11, wherein the anomaly is a non-electrical anomaly.

13. A secured electrical system comprising a secured power supply system according to claim 11, and a device supplied by said secured power supply system.

14. An electrical installation comprising a secured electrical system according to claim 13.
